(19) United States
(12) Patent Application Publication
(10) Pub. No.: US 2013/0196307 A1
(43) Pub. Date: Aug. 1, 2013

(54) VISUAL ORGANIZER

(71) Applicants: Tricia Sulpizio Estrada, La Jolla, CA (US); Rogelio Martin Estrada, La Jolla, CA (US); Petru Bogdan Bocsa, Windsor (CA)

(72) Inventors: Tricia Sulpizio Estrada, La Jolla, CA (US); Rogelio Martin Estrada, La Jolla, CA (US); Petru Bogdan Bocsa, Windsor (CA)

(73) Assignee: BRIGHTER FUTURES FOR BEAUTIFUL MINDS, La Jolla, CA (US)

(21) Appl. No.: 13/363,160

(22) Filed: Jan. 31, 2012

(51) Int. Cl. G09B 29/00

(52) U.S. Cl. 434/430

(57) ABSTRACT

Systems and methods are provided for teaching and improving a subject user's (e.g., child's) educational and social development, including learning independent management of their own schedule, learning key developmental higher functioning strategies of order, planning, prioritization and time management. Moreover, systems and methods are provided to allow for interactive and collaborative mechanisms for parents, educators, and other entities to monitor, manage, and participate in a child's educational and social development. An application in the form of a visual organizer utilizes visual displays, cues, and aids, such as photographs, to accompany assigned activities, instructions, etc. so that a child may better follow or participate in such activities, instructions, etc. Adults are able to create child profiles and may connect, message, schedule, network, and otherwise interact with a child and other individuals for the betterment of the child's daily organization, time management, and motivation in a coordinated manner.

### TECHNICAL FIELD

The present invention relates to organizational, networking, and motivational systems and methods, and more particularly, to incorporating visual aids into such organizational, networking, and motivational systems and methods for, e.g., children, adults, students, etc.

### BACKGROUND

Children often benefit from learning organization and time management skills, even at a young age. For example, children as early as five or six years of age can begin to understand the basics of sequencing and order, which in turn help children understand how to create and follow a schedule. Moreover, the developmental process of learning executive functioning and higher order processing skills allow for better organization and time management. These abilities extend through to adulthood so as children mature, they are better able to management assignments, tasks, activities, etc., whether in school, at a job, or in their personal life.

From a parental perspective, the ability to interact and communicate with other persons and/or entities involved with raising and/or educating a child, such as educators, therapists, coaches, etc. would be advantageous to that child's development. For example, children would benefit from consistent and coordinated feedback/reinforcement and support regarding their education and activities. Educators, counselors, therapists, and other caregivers as well would benefit from having the ability to more easily interact with parents and other caregivers or educators, as well as manage their relationships with children, parents, therapists, etc.

While educators, therapists, and the like reference the need, or at least the advantages of utilizing visual aids or graphics as learning tools for children or as therapeutic tools for developmentally-challenged children or those with non-traditional learning needs, limited tools currently exist. Older methods that are frequently used simply include printing out photographs and using Velcro® to give the child tactile interaction. Hence, it would be advantageous to provide such a visually-based interactive tool to assist in the education/development of children. Moreover, it would be advantageous to provide such a tool to assist in the education/development of any person, whether younger or older, e.g., teenagers, college students, adults with needs, etc.

### SUMMARY

Various aspects of examples of the invention are set out in the claims.

According to a first aspect of the present invention, a method comprises providing an interactive graphical user interface including a schedule comprising at least one activity for a subject user utilizing the first device. The method further comprises associating at least one visual element with the at least one activity, the at least one visual element being a subject user-oriented representation of the at least one activity. Moreover, the method comprises displaying the interactive graphical user interface including the schedule comprising the at least one activity with the associated at least one visual element.

According to a second aspect of the present invention, a computer-readable memory includes computer executable instructions, the computer executable instructions, which when executed by a processor, cause an apparatus to perform at least the following: provide an interactive graphical user interface including a schedule comprising at least one activity for a subject user utilizing the first device; associate at least one visual element with the at least one activity, the at least one visual element being a subject user-oriented representation of the at least one activity; and display the interactive graphical user interface including the schedule comprising the at least one activity with the associated at least one visual element.

According to a third aspect of the present invention, an apparatus comprises at least one processor, and at least one memory including computer program code, the at least one memory and the computer program code configured to, with the at least one processor, cause the apparatus to perform at least the following: provide an interactive graphical user interface including a schedule comprising at least one activity for a subject user utilizing the first device; associate at least one visual element with the at least one activity, the at least one visual element being a subject user-oriented representation of the at least one activity; and display the interactive graphical user interface including the schedule comprising the at least one activity with the associated at least one visual element.

According to a fourth aspect of the present invention, a system comprises: a first device executing a first instance of an interactive visual organizer application; a second device executing a second instance of the interactive visual organizer application; and a data network communicatively connecting the first device and the second device, the data network ensuring synchronization of the first instance of the interactive visual organizer application and the second instance of the interactive visual organizer application. The interactive visual organizer is configured to: provide an interactive graphical user interface including a schedule comprising at least one activity for a subject user utilizing the first device; associate at least one visual element with the at least one activity, the at least one visual element being a subject user-oriented representation of the at least one activity; and display the interactive graphical user interface including the schedule comprising the at least one activity with the associated at least one visual element.

According to a fifth aspect of the present invention, a method comprises providing, on a computing device, an interactive graphical user interface including a visual journal, and presenting to a user of the visual journal, a plurality of graphical elements each representative of a mood. The method further comprises receiving, via selection of at least one of the plurality of graphical elements, at least one input corresponding to a self-perceived mood of the user of the visual journal, and storing, on a memory unit of the computing device, the selection of the at least one of the plurality of graphical elements.

According to a sixth aspect of the present invention, an apparatus comprises at least one processor, and at least one memory including computer program code, the at least one memory and the computer program code configured to, with the at least one processor, cause the apparatus to perform at least the following: provide an interactive graphical user interface including a visual journal; present to a user of the visual journal, a plurality of graphical elements each representative of a mood; receive, via selection of at least one of the plurality of graphical elements, at least one input corresponding to a self-perceived mood of the user of the visual journal; and store, on a memory unit, the selection of the at least one of the plurality of graphical elements.

### BRIEF DESCRIPTION OF THE DRAWINGS

For a more complete understanding of example embodiments of the present invention, reference is now made to the following descriptions taken in connection with the accompanying drawings in which:

FIG. 1a is an exemplary visual organizer calendar screen for a child in accordance with one embodiment of the present invention;

FIG. 1b is an exemplary visual organizer schedule screen for a child in accordance with one embodiment of the present invention;

FIG. 2 is an exemplary visual organizer parent schedule screen in accordance with one embodiment of the present invention;

FIG. 3 is exemplary visual organizer individual lesson screen for an educator in accordance with one embodiment of the present invention;

FIG. 4 is an exemplary visual organizer group lesson screen for an educator in accordance with one embodiment of the present invention;

FIG. 5 is an exemplary visual organizer group management screen for an educator in accordance with one embodiment of the present invention;

FIG. 6 is an exemplary visual organizer message wall screen for a parent in accordance with one embodiment of the present invention;

FIG. 7 is an exemplary visual organizer mood journal screen for a child in accordance with one embodiment of the present invention;

FIG. 8 is an exemplary visual organizer home screen for a child in accordance with one embodiment of the present invention;

FIG. 9 is an exemplary visual organizer home screen for a parent in accordance with one embodiment of the present invention;

FIG. 10 is an exemplary visual organizer sharing screen for a parent or educator in accordance with one embodiment of the present invention;

FIG. 11 is an illustration of an exemplary system architecture within which various embodiments of the present invention may be implemented;

FIG. 12 is a flow chart illustrating exemplary processes performed in accordance with various embodiments of the present invention; and

FIG. 13 is a flow chart illustrating exemplary processes performed in accordance with other various embodiments of the present invention.

### DETAILED DESCRIPTON

Systems and methods are provided for teaching and improving children's educational and social development, neural processing executive functioning, and higher order processing skills, as well as for providing interactive and collaborative mechanisms for parents, educators, and other entities to monitor, manage, and participate in a child's educational and social development. In particular, an application in the form of a visual organizer that may be embodied/implemented on a device, such as a computer, smartphone, tablet personal computer (PC), personal digital assistant (PDA), multimedia device, etc. allows for every interaction, comment, schedule, lesson, or other activity or event to ultimately aide and assist a child's home, school, and overall life success. Parents, educators, therapists, etc. are able to create child profiles and may connect, message, schedule, network, and otherwise interact with a child and other individuals for the betterment of the child's daily organization, time management, and motivation in a coordinated manner.

Furthermore, when a child is able to interact with a program that child is able to process and learn using different sensory inputs. Children will be able to mark a task complete, leave feedback regarding different activities, and journal their mood during the day, all of which may be recorded and sent to the parent/teacher of the child. Children will also be driven by points and prizes for task completion. The points/prizes reward model helps children stay motivated to complete their activities and focused to stay on task. Additionally still, children may be given the opportunity to view comments made by others as feedback to their own progress. To achieve such goals, the application utilizes visual/graphical displays, cues, aids, etc. which engage all children, but fulfill a visual learning need for children with certain developmental challenges, such as autism spectrum disorder, or less than optimal reading skills. Utilizing such visual/graphical tools allows for, e.g., photographs, images or videos, to accompany assigned tasks, instructions, events, etc. so that a child may better follow or participate in such tasks, instructions, events, etc.

In order to begin utilizing the visual organizer, an account with an associated profile is created for one or more children. To create such a profile, a parent, educator, or other entity will “download” the visual organizer to their mobile device or computer. A parent may create a profile for one or more of his/her own children, while a teacher, therapist, etc. may create a profile for a child he/she interacts with.

When a parent creates a child's profile, that parent has the option of adding other adults or entities to that child's network, such as teachers, therapists or family members. The parent may specify the level of access each of these additional adults may have to each child's profile. For example, the parent may allow full access or read only access to their child's account. If another adult has, e.g., full access, to a child's profile, that adult may schedule or create activities for the child, as well as communicate back and forth directly with the parent or other shared adults on a message wall. This will help in facilitating and coordinating the efforts and scheduled activities of teachers, therapists, etc., as well as develop an effective learning curriculum. If an entity has read only access, that entity may then only, e.g., monitor, a child's schedule, mood, etc. without being able to add, delete, or otherwise alter a child's information, activities, etc. An adult with read only access may also read and send messages to other shared adults of the child's network.

As an educator or therapist, profiles for one or more children in their class or children they work with may be initiated if the parent(s) of those children have not yet set up a profile(s). The educator/therapist may be thought of as the child's account administrator. As an account administrator, the educator may grant differing levels of access to the parent(s) as described above. For example, read only access to a child's account/profile may be effectuated for communication purposes to show the parent(s) the activities and schedule the child will be completing while with the educator.

It should be noted that in accordance with various embodiments, one or more security measures, including, but not limited to the following examples, may be implemented in order to protect the privacy interests of a child, parents, etc. For example, a default characteristic of an educator's permissions may include not being able to “share” (to be discussed in greater detail) the child with any other adults, as only one or more parents is authorized to share the child's account/profile with other entities. Another example may be that reports for a particular child may only be sent to that child's parent(s). Precautions are taken to protect the identity of the child, by never allowing a child's name to be “searched” within the application/system.

Along with the idea of “sharing” the child with one or more adults, different embodiments of the present invention may be pre-configured to operate with varying levels of sharing. For example, a first configuration may be a “lite” version, where a child is not allowed to be shared with other adults. A more inclusive or “pro” version may be configured such that sharing is allowed. Further still, different embodiments may have one or more features described herein enabled/disabled according to a user's needs/desires/comfort. For example, and as will be discussed in greater detail, one embodiment of the present invention may implement only a mood journal aspect (or implement the mood journal as a main focus) of the visual organizer application. Another implementation may involve only scheduling and mood journal functionality without a messaging function. It should be noted that any combination of functionalities described or contemplated herein is possible.

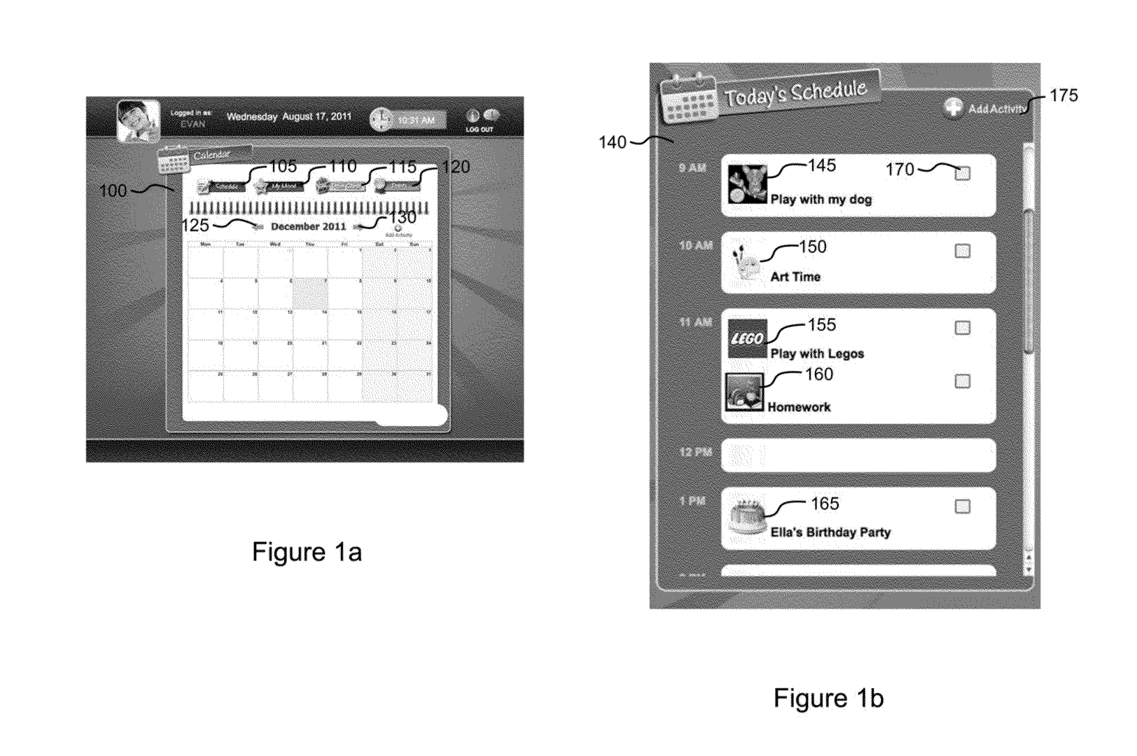

As previously alluded to, various embodiments of the present invention are directed, in part, to helping children understand and manage their own schedules while learning valuable higher order processing and executive functioning including time management and organizational skills, as well as providing motivators for completing activities. FIG. 1a is an exemplary calendar 100 that may be created and displayed to a child. In FIG. 1a, the relevant child for which the calendar has been created and displayed to is “Evan.” The calendar may be populated with various items or information, such as scheduled activities shown as text coupled with an appropriate icon. Additionally, and from the calendar view illustrated in FIG. 1a, the child may navigate, using the application, to other views/aspects of the application by clicking or selecting such aspects. For example, “buttons” or selectable icons, such as icons 105, 110, 115, and 120, will allow a child to navigate to his/her schedule, mood journal, prize chest, or points summary, respectively. Additionally, the child may navigate to, e.g., a previous or future month using arrows/buttons 125 and 130. It should be noted that these icons/text/buttons may be pointers, hyperlinks, or other appropriate identifier depending on how the application is implemented, as will be discussed in greater detail.

FIG. 1b is an illustration of an exemplary schedule screen or display 140 associated with the calendar of FIG. 1a, and may be configured as a daily schedule, or some other desired time period. As illustrated in FIG. 1b, the schedule 140, in accordance with various embodiments, is visual with the option to incorporate images, photos, or other visual/graphical cues or tools 145, 150, 155, 160, and 165 for representing activities, events, etc. that are applicable to the child. Additionally, such visual aids may be utilized for presenting step-by-step instructions involved in the aforementioned activities, for example, with images for each task associated with an activity or assigned lesson. Further still, a child may indicate completion of an activity, task, event, step, etc. by checking a box 170 associated with each activity, task, event, step, etc. It should be noted that in the case of e.g., a lesson with multiple steps which a child must complete, the lesson can be displayed with a check box for each step in the lesson, or a single check box to be checked upon completion of the entire lesson. Such variations are configurable by a parent, educator, etc. It should be further noted that only parents, teachers, or adults that the parent(s) have allowed access, may create or schedule any activity for the child. The child will have the option to view his/her daily schedule such as that illustrated in FIG. 1b or view a calendar such as that illustrated in FIG. 1a with a monthly view of their activities.

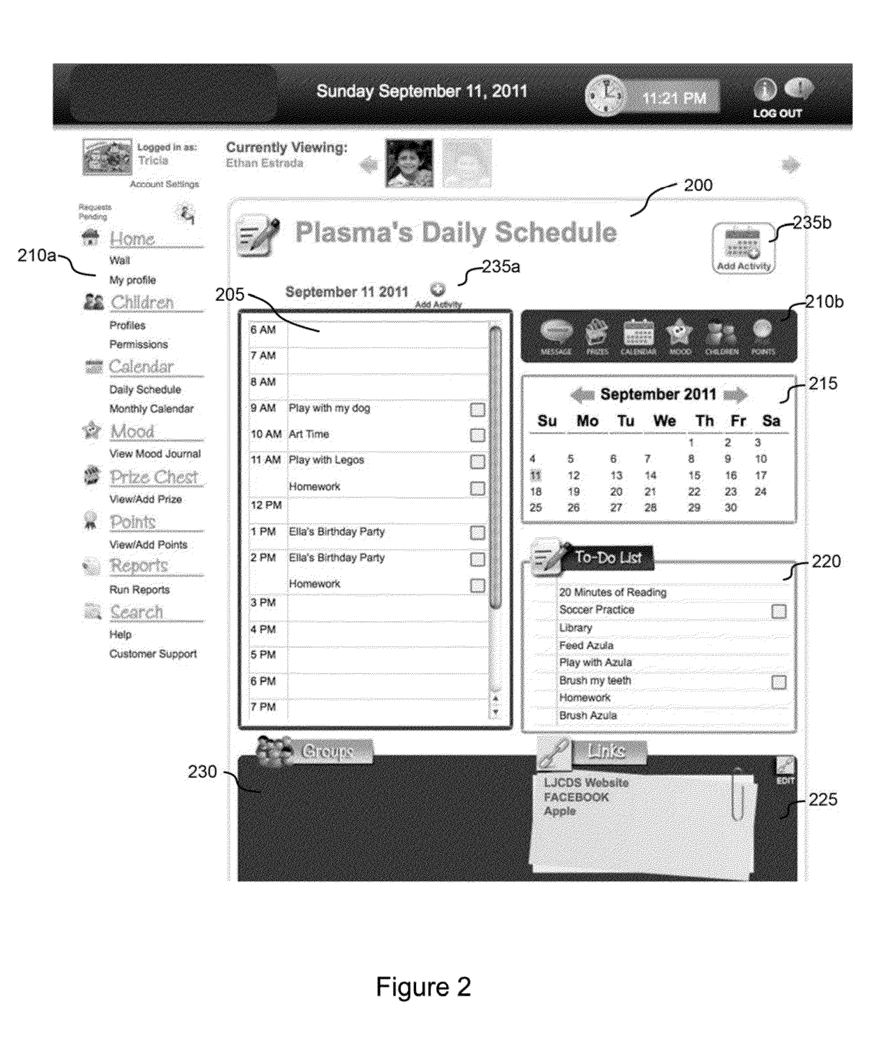

The parent(s) and other shared educators will also be able to view the activities of the child using at least one of a calendar and schedule. FIG. 2 illustrates an exemplary daily schedule 200 for a particular child that would be displayed to a parent or educator. As illustrated in FIG. 2, the schedule 200 is a daily schedule, wherein activities, events, etc. are displayed in a daily schedule area 205. Additionally, and similar to the schedule 140 of FIG. 1b, the parent may navigate, via one of two navigation areas 210a and 210b, to other views or aspects of the application, e.g., a message wall, a prize chest, a calendar, a mood journal, etc. Moreover, a calendar 215 with “links” to specific days may also be displayed to a parent, where selecting a particular day will display the relevant schedule for that day in the daily schedule area 205. Further still, a to-do list 220 may be displayed, as well as a links area 225 where hyperlinks, uniform resource locators (URLs), or the like may be displayed, and a groups area 230 (which will be discussed in great detail below). As FIG. 2 illustrates a schedule for display to a parent, educator, or other adult entity, it is not necessary to show visual/graphic icons or cues, but in accordance with other embodiments, the same visual/geographical items displayed to a child may also be displayed to an adult.

As utilized herein, the term “event” refers to a scheduled activity or pursuit that a child may undertake with an associated date, but no time associated with the event. Hence, events refer to activities without a set time of day for that activity to occur, but are nonetheless identified in a child's schedule for a specific day. Examples of events include, but are not limited to, birthdays, holidays, other reminders for a particular day, such as a reminder that a certain book report assignment is due, etc. Such events may be displayed first on/at the beginning of a child's schedule as a particular day's first event(s). It should be noted that events may, but need not be associated with a completion box/action for a child to manage. It should further be noted that the aforementioned events may be associated with a time, e.g., an actual birthday “party,” at the discretion of the child, parent, educator, etc., thus characterizing the event as an activity.

As utilized hereafter, the term “activity” refers to an activity or pursuit scheduled with a date and time. Such activities can include soccer practice, other types of scheduled activities, whether scholastic or extra-curricular, activities, before, during, or after school, or any pursuit that a child needs to complete, is obligated to attend, etc. on a particular day at a specific time. For example, Figures lb and 2 illustrate a child's schedule that includes an activity labeled/described as “Play with my dog” that is scheduled to occur at 9:00AM on a particular day. At 10:00AM, on the same schedule, the child is to engage in “Art Time.” At 11:00AM, the child is scheduled to “Play with Legos.” All activities and to-do activities (to be described in greater detail) may be marked complete and feedback may be written about each activity or to do. The parent/educator will be notified when an activity is marked complete or feedback is left. Unlike events, which are not necessarily associated with a completion box, activities, as illustrated in FIGS. 1b and 2, each have a box (e.g., box 170 of FIG. 1b) which may be checked by a child upon completion/passing of the activity.

It should be noted that the scheduling of more activities is generally recognized to help children who may require more help in focusing on completing their daily schedule. Having more activities generally allows children to have clear expectations of their day in that they will feel more comfortable knowing what activities they have to complete/what is expected of them that day. Moreover, the association of visual aids/cues/tools with such activities provides further confidence and comfort for a child whose reading skills may need developing, as well as making interaction with the schedule more entertaining and captivating. Children who learn executive functioning skills early in life, such as scheduling, order priority, and planning will be better prepared to independently schedule and prioritize their activities as they get older.

In accordance with various embodiments, each activity may optionally include step-by-step instructions with photos, images, etc., “showing” each step a child must perform in order to complete the activity. Each step of the activity may optionally be associated with a completion box allowing the child to manage his/her progress in completing the action by checking off each completed step.

Additionally, points may also be associated with each step, such that upon completion of each step, (e.g., if the parent sets up the activity as separate steps on the schedule, where essentially, each instructional step would be an activity) a predetermined number of incentive/motivator points may be added to a child's point total. Collected points may then be used to redeem prizes. Moreover, and if desired, links, e.g., Uniform Resource Locator (URL) links, may be associated with one or more of the redeemable prizes such that when a prize is able to be redeemed, an authorized entity, such as a parent, will be linked/forwarded to an online store, for example, where the prize can be purchased.

The application, in accordance with various embodiments, further allows children to provide feedback regarding one or more activities. That is, a child will be able to write feedback about that activity, such as if the child enjoyed the activity, whether the activity was too hard or too easy for the child, etc. For example, a pop-up window or interface may appear upon the child checking a completion box for a particular activity or step of an activity. The interface will provide a mechanism for the child to enter his/her thoughts regarding the activity or activity step, and the feedback will be saved. In devices that allow voice recording, the interface may allow the child to simply record his/her thoughts regarding the particular activity or activity step instead of requiring textual feedback to be entered, which may especially useful again, for children whose reading and/or writing skills need further development. Parents will also have the option of recording the name of the activity or the instructional step so that a child may hear the title of the activity or instruction, rather than having to read it. This will be useful for younger children or children who are not able to ready very well.

As will be discussed in greater detail, implementation of the application may be achieved as a web-based application, where such feedback would be uploaded to a database or data repository accessible by the application. Alternatively or additionally, if the application is implemented on a device having communication capabilities such as a smart phone or tablet PC, the feedback may be uploaded to the data repository using that device's resident communication functionality. Alternatively still, such feedback may be saved locally on a memory unit of the device, such as a resident memory unit, removable flash memory device, etc., to be later retrieved, downloaded to another device, such as a parent's smart phone or tablet PC which is running another instance of the application, or the same device which may also be running a parent or educator instance of the application.

It should be noted that activities themselves, which are created by each user (e.g., parent, educator, etc.) may be saved for future use. Thus, if a user wishes to create another instance of an existing activity at a later time, the details of the activity need not be re-entered. Rather, each activity will be searchable, and will be able to be used for future calendar days with saved instructions, images, etc.

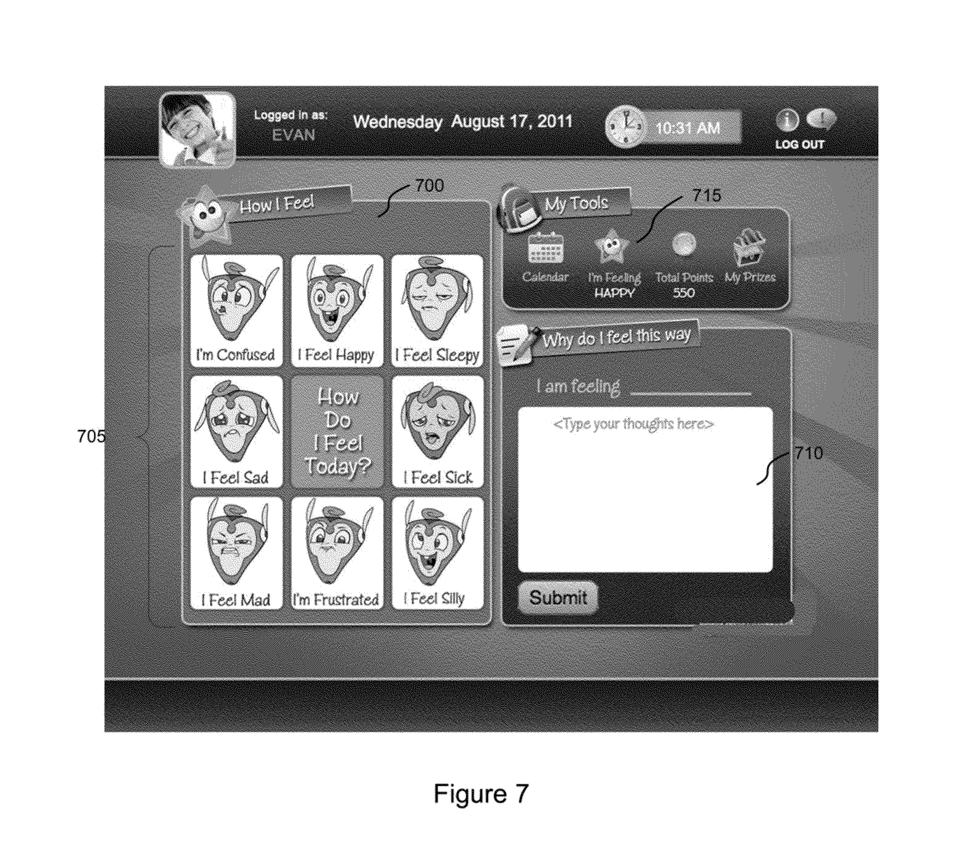

FIG. 2 illustrates a to-do list 220 that may be displayed comprising to-do activities. As utilized herein, the term “to-do” refers to activities, having neither an associated time nor date, that a child must complete. Such to-do activities may appear on a child's schedule under a separate list from the child's calendar or schedule (e.g., in a to-do list as illustrated in FIG. 7). To-do actions may be automatically or manually removed from a to-do list upon completion of activity/task, such as packing for a trip, finishing some project, etc. Alternatively, to-do activities can be left on a to-do list if the to-do activity is an on-going activity or task that needs to be completed more than once, such as feeding the dog, doing a daily 20 minutes of required reading, etc

To-do activities are separated from a child's calendar and schedule so as to not have too many items on the calendar/schedule, especially if the to-do activities do not necessarily need to be completed on a particular day, but again, are recurring tasks or other activities that simply do not need to be on a child's calendar or schedule every day. Like the aforementioned activities, activity steps, and events, to-do activities will also have the option to be associated with visual aids such as photo representations, step by step photo instructions, feedback input, completion box management, as well as points for completion. Also like the aforementioned activities, activity steps, and events, to-do activities created by each user will be saved for future use, and each to-do activity will be searchable, and will be able to be used for future calendar days with saved instructions and images.

In the event that a user wishes to create a “private” activity, event, or to-do activity, the user creating the activity may denote it to be a private activity. Thus, only the user that created the private activity (if that user is an adult), the child for which the private activity is directed, and the child's administrator may view the private activity. In other words, the calendars/schedules of the aforementioned user are the only calendars/schedules on which the private activity will be displayed.

In accordance with various embodiments, children, in addition to parents, educators, and the like, will also have the option of adding activities, events, etc. to their own calendars. Allowing children to participate in organizing their own day, create their own activities, etc. teaches independent scheduling and activity management. However, a child will not be able to edit or alter any activities, events, to-do activities, etc. that have been assigned by a parent, administrator, other adult, etc., while an administrator or parent may, e.g., delete any activity assigned to a child by the child him/herself, or a shared adult. Shared adults may only delete activities they themselves have scheduled/assigned.

With regard to educators and/or therapists, and in accordance with various embodiments, lessons may be created, saved, and assigned to students/children or groups of students/children. For example, educators may create and manage custom, visually-based lessons, schedules, or tasks for students to follow independently throughout a student's day. Alternatively, lessons may be created or customized to work in conjunction with a student's school or classroom tasks, projects, lessons, etc. The ability to customize lessons in accordance with various embodiments allows educators, therapists, and the like to tailor lesson plans and/or schedules to specific students, as well as allows children to follow lessons at their own pace. Lessons may comprise one or more activities or sets of activities, and may have instructions (along with visual aids/cues, or videos), details of what the lesson is, and/or what the child has to accomplish/perform to complete a lesson. Moreover, lessons will have the same features of an activity, event, etc. as described above, such as feedback input options from children/students, completion management options allowing the educator, parent(s), and children themselves to track progress, etc. If an educator is the child's “admin” or “owner,” the educator will receive the feedback from the child, and will also have the option to share the child with other educators, yet only the “owner” of the child will be allowed to see the feedback and share a child.

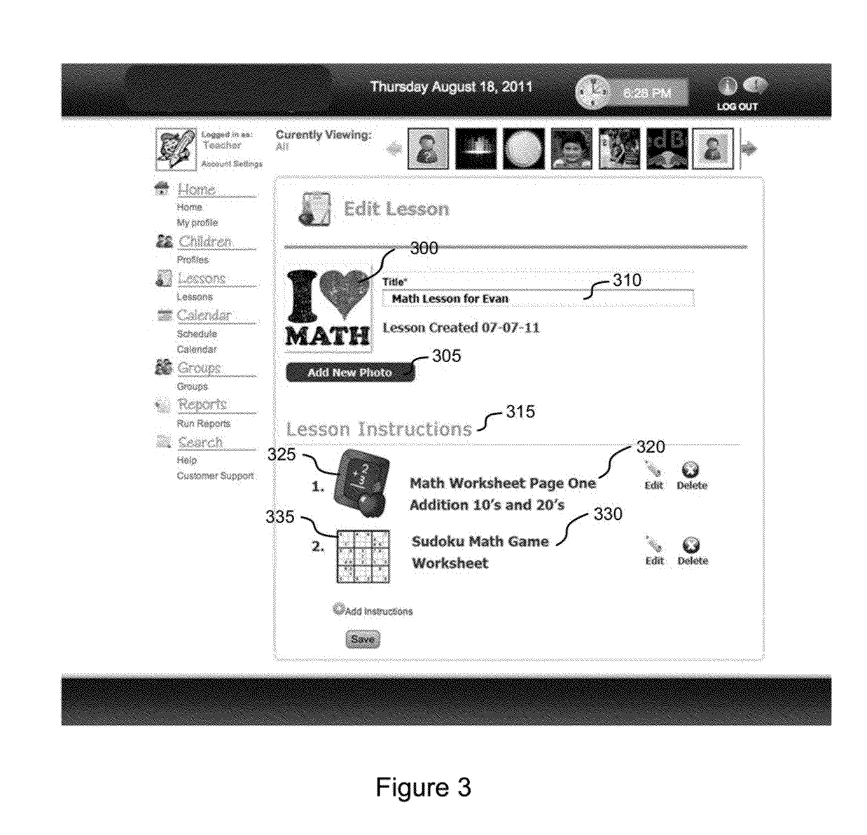

FIG. 3 is an exemplary screen shot that might be displayed to an educator for creating/editing a lesson in accordance with various embodiments. As indicated previously, lessons may be associated with visual aids, such as a photo 300, which may be customized via an option to add a new photo 305, and may be titled and/or described at 310. FIG. 3 also illustrates lesson instructions 315, which may comprise one or more specific activities or tasks 320 and 330, each of which may be associated with a visual or graphic 325 and 335, respectively.

It should be noted that lessons created by an educator may be publicly posted and, e.g., searchable by title, description, etc., if desired, for other educators to see, utilize with their own students/children. For example, and as discussed previously, the application in accordance with one embodiment may be implemented as, e.g., a web-based application, where users login to the application for access. In accessing the application, users such as educators may peruse a lesson library for previously created lessons. Additionally, and as will be discussed in greater detail, an education may include other educators in a group, allowing those other educators at least read only access to lessons.

Moreover, lessons would be visible to any other entities that share the profile of a child or group. For example, educators may provide a parent(s) with access to their child's lesson plan and/or schedule to allow the parent(s) to see what the child's daily activities are. Additionally, and utilizing the messaging aspect of the application (to be discussed in greater detail), educators can communicate with parents as needed/desired to foster communication and cooperation, as well as to apprise parents of a child's progress.

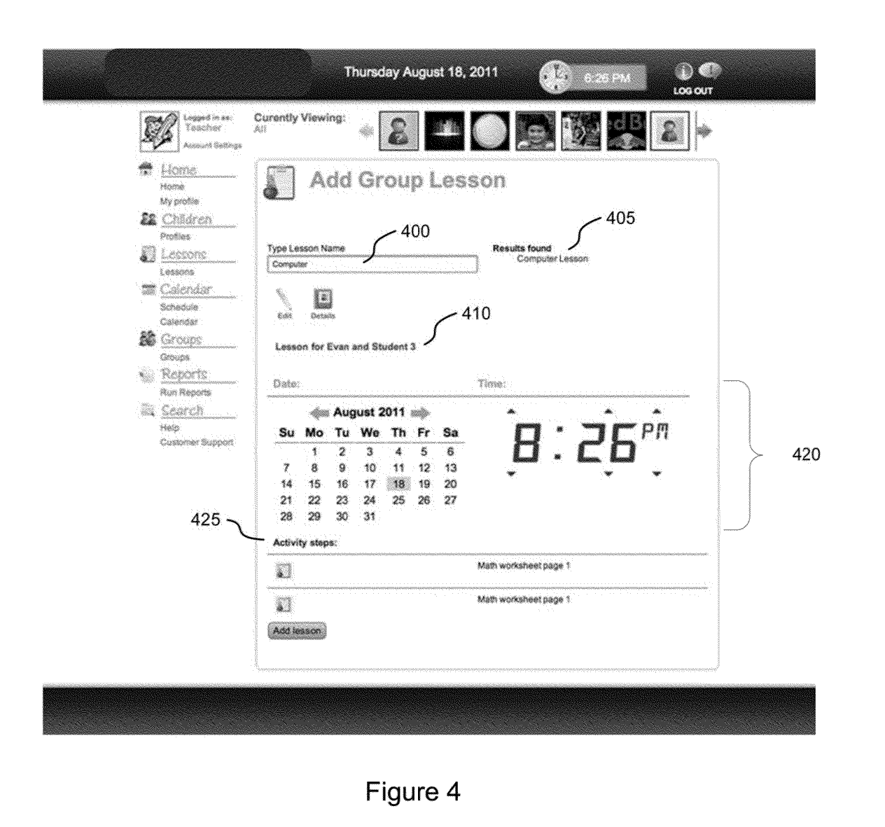

FIG. 4 is an exemplary screen shot illustrating the addition of a group lesson in accordance with one embodiment of the present invention. In this instance, a search was performed for “computer lesson” at 400 and a resulting lesson was found at 405. The lesson may be created/assigned to a group of students, in this instance, comprising “Evan” and “Student 3.” A date and time may be associated with the group lesson, as illustrated at 420, while ac steps may be created, described, associated with visuals or graphics at 425.

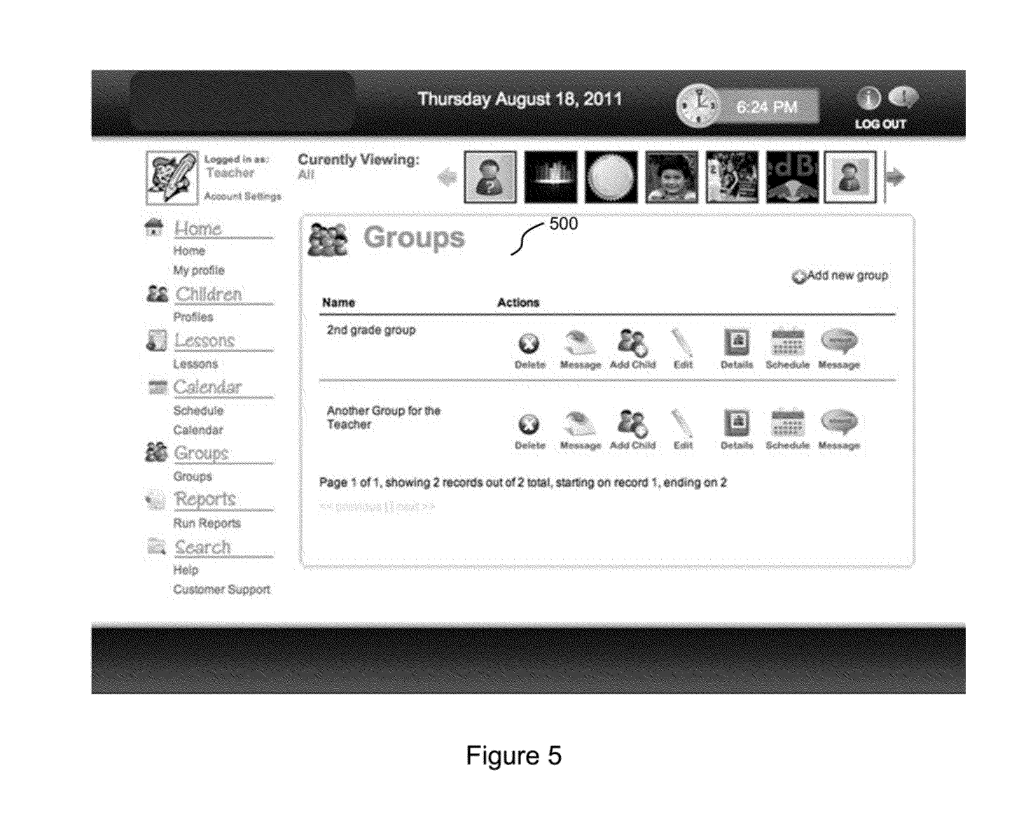

Groups themselves may be managed by, e.g., an educator, via the application. For example, groups can be created and named, deleted, and/or edited. Children can be added to or deleted from one or more groups. Details may be entered regarding one or more groups, schedules may be created for groups, and messages may be sent to groups. An exemplary screen shot indicative of group management screen 500 is illustrated in FIG. 5. Each group that an educator creates will have its own unique home summary page allowing for easy communication to the group and parents/members of this group. This may include group scheduled lessons and assignments, as well as special group notes. An educator will also be able to add administrator access to another adult to allow that other adult to post to the group calendar and homepage group summary. Such a feature may be helpful for, e.g., a “room mom” to keep the parents in the group aware of all of the specific group (or classroom) activities.

When activities, events, to-do activities, or lessons are created, the creating parent, educator, or entity may utilize default icons/visual cues or videos that automatically appear when a particular event is created. For example, when an event for a birthday party is created, the application recognizes the selection of the event, typed text associated with the event, or some combination thereof and offers appropriate icons and shows images related to the typed text to allow the user to choose the image they wish to use. That is, a parent may select a date and time and begin typing in a description or title of the event. If the application recognizes certain text as being a particular type of activity, the application matches that activity with icons to choose from.

Alternatively, the user creating an activity may be presented with a menu or selection of icons/visual cues to associate with a created activity/event/etc. Hence, upon creating an event, a selection of icons will be automatically presented to, e.g., a parent, or the parent can manually initiate an icon selection process as illustrated in, e.g., FIG. 3.

Alternatively still, the user creating an activity may, e.g., take a photograph and use that as a graphic for an activity. For example, a parent may wish to create an activity related to a child's school work. In that case, the parent may initiate creation of an activity, and then take a photograph of the relevant book that the child is to read/study for a particular assignment. This photo can then be associated with the created activity and used instead of a default/predefined icon or generic icon/graphic. To achieve this aspect of the application, the application may include a photographic feature, or a device's resident photographic feature(s) may be utilized, as many electronic devices, such as smart phones, tablet PCs, etc. are capable of taking photos. A parent/educator may also wish to utilize a personal picture taken previous to the creation of an activity. Hence, existing photos/graphics may be uploaded to a device upon which the application is executing, and via the application, the photo may be accessed for use. It should be noted that although the visual aids/cues/tools described herein in accordance with various embodiments are, e.g., static media, such as photos, other media may also be utilized such as audio, video, or any combination thereof. Users may also use other graphics or icons from their own computer.

As previously alluded to, the application comprises, in part, a messaging aspect, in particular, a message posting system for parents, educators, or other adults shared within a child's network. Anyone who is shared to a child's profile is able to post a message related to the child to either the parent of that child or any other adult shared with that child. The child's administrator (e.g., an educator, parent or some other adult that has set up the child's account) may be copied on every message that is sent through the child's account, although it is preferable, for, e.g., security interests, that an administrator is always copied on every message. When a message is sent through the child's account, every adult who is shared with that child will be able to see these messages.

There is an option to send a “private message” in which a message is sent directly to a desired adult. However, the administrator is still copied even in the case of a private message. As a first example, a private message can be sent directly to a parent administrator associated with the child's account. Only that parent will see the private message. According to another example, a teacher may send another teacher a private message through the child's account. The parent administrator will also see a copy of the private message, although no other shared adults will see the private message.

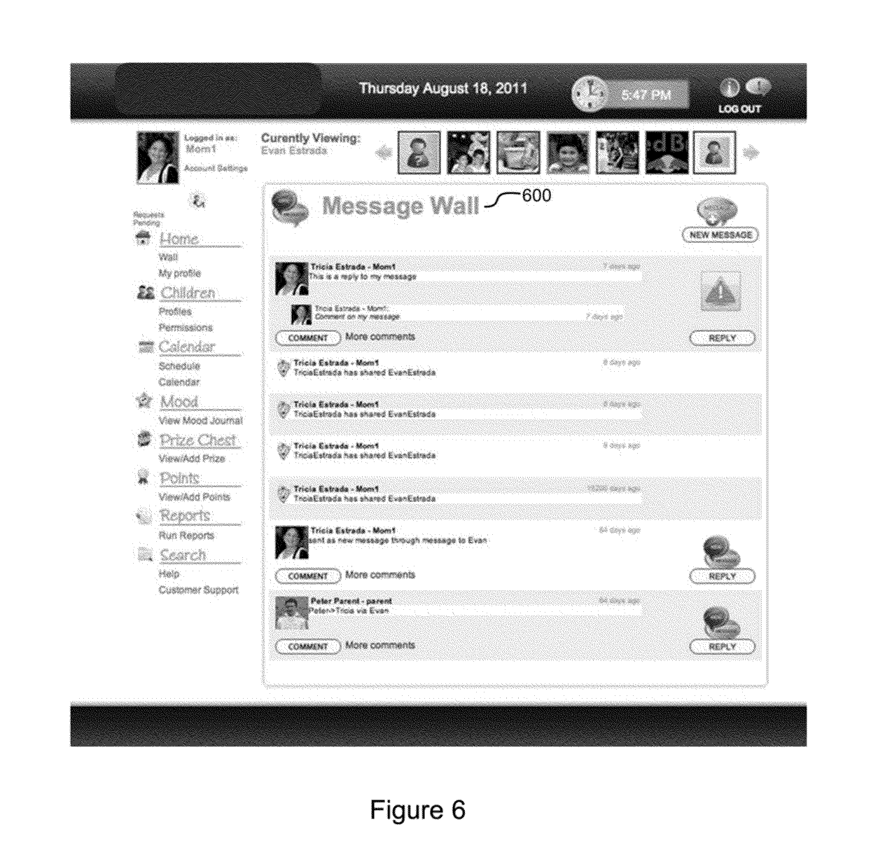

Moreover, a message wall 600, such as that illustrated in FIG. 6 will display/have posted thereon automatic updates linked to a child's activities on the system. The following messages may be sent to a parent administrator's message wall: messages indicating that a task, lesson or activity has been completed, including any points added to the child's account as a result of completing that activity; messages indicating that a child has input feedback to an activity, event, etc.; messages indicative of a child adding an event to his/her calendar; messages indicative of a when a child updates his/her mood or writes in his/her mood journal; messages indicating that a child has used or redeemed his/her accumulated points for a prize reward; and messages indicative of when a shared adult adds points to a parent administrator's child account. Further still, information, such as the time a message was posted, replied to, forwarded, etc. may be indicated on the message wall 600. It should be noted that the message wall 600 is configured to allow messaging between shared adults, while as previously indicated, on the administrator/owner of the child receives, for example, automatic triggers of task completion, feedback, and mood journal entries. However, an administrator can choose to repost such messages/notifications for other entities. Moreover, it should also be noted that more than one parent or adult may be configured/set up as a child administrator.

Other options related to messaging in accordance with various embodiments include, but are not limited to sending a new message, replying to any posted message, and making a comment regarding a particular message. Moreover, communications via mechanisms other than the messaging aspect of the application may be utilized. For example, email alerts may be sent to one or more email accounts of, e.g., parents, educators, etc. for various stages of a child's progress, e.g., when a child's accumulated points near the number needed to redeem a prize, if a child has completed all of his/her tasks for a day, etc.

in accordance with another aspect of the present invention, a mood journal is provided to allow a child to enter or note his/her mood during the day. For example, FIG. 7 illustrates such a mood journal 700, where the child may select from an assortment of preloaded icons 705 representative of different emotions. A child will also be able to write freeform text and journal entries at 710. Alternatively, and as described above, depending on the recording capabilities of the device on which the application is implemented, a child may also be able to record his feelings via voice. The administrator for the child will receive an automatic wall post when a child enters or notes his/her mood, or types/records something on the mood journal 700. It should be noted that the application may be configured such that information regarding a child's mood will not be editable or deleted by the child after it has been entered and saved. Additionally still, a current indicator of the child's mood 715 may be displayed.

As described above, a child may receive points for completing certain activities, to-do activities, attending/engaging in events, etc. A parent, shared adult, or other administrator, educator, etc. may also add to or subtract points from a child's account as desired. Accumulated points may be used to redeem one or more prizes set up by, e.g., an account administrator. Running point totals may be displayed to a child in the application, as well as a prize “booth” that presents available prizes to the child. Parents or administrators will be able to set up an unlimited amount of different rewards and prizes, and will be able to post an image of the prize, a description and the number of points needed to earn each prize, as well as add, e.g., URL links, to one or more websites, online stores, etc. where a prize can be purchased/contains information regarding the prize. It should be noted that various actions can be taken with respect to prizes, such as automatic removal from the prize booth upon a child redeeming the points for that prize, reposting of a prize, configuring how many prizes are available, determining and indicating how many points are needed for any prize, etc.

In accordance with yet another aspect of the application, the administrator of a child's account may run and print different reports regarding a child's activities, progress, moods, etc. based on, e.g., a chosen period of time, or any parameters for which information/data exists. For example, a report may be run based on a child's noted moods, or certain activities engaged in by a child, etc. The printing of reports may be achieved if a device has printing capabilities or can be connected to a printing/presentation device for rendering in that manner. Reports as well, may be displayed to a user on the device upon which the application is implemented, and may also be emailed, messaged, or otherwise communicated to a user in an appropriate electronic format.

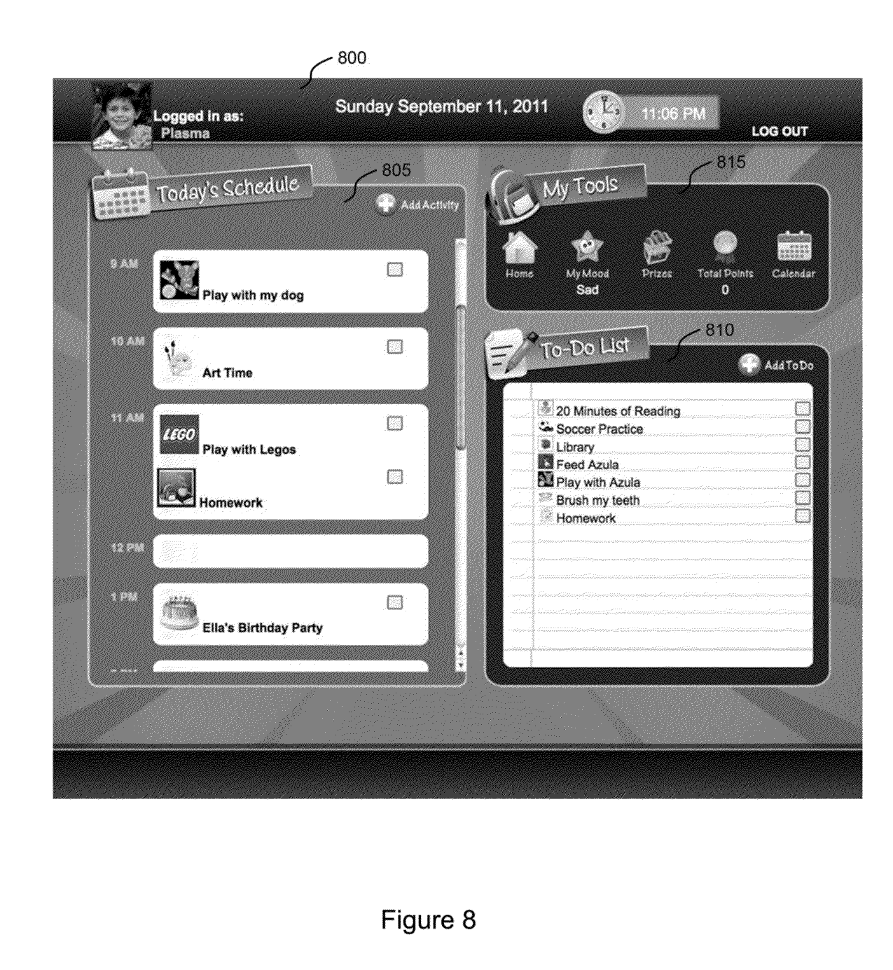

As previously described and illustrated in, e.g., FIGS. 1-7, each user, whether a child, a parent, an educator, etc. may have their own interface and unique log in when utilizing the application in accordance with various embodiments. A child's interface, as alluded to previously, will have a special child interface with graphics and a developmentally appropriate and understandable design for a child to use and mange their account/profile, schedule, etc. Additionally, and as illustrated in FIG. 8, the child will have views of a daily home page 800, including their daily schedule 805, and to-do activities list 810, each with clickable activities showing, e.g., instructions for performing/completing the scheduled items. Additionally, a tools area 815 may have icon links to the child's calendar, mood journal, prize booth, point totals, current mood, etc. Children can be given the option of manipulating the view of the icon placements as well as themed backgrounds and overall page or screen appearance. Further still, “mini motivators” may be presented to a child during interaction with the application, such as the presentation of animated effects when a child completes a task.

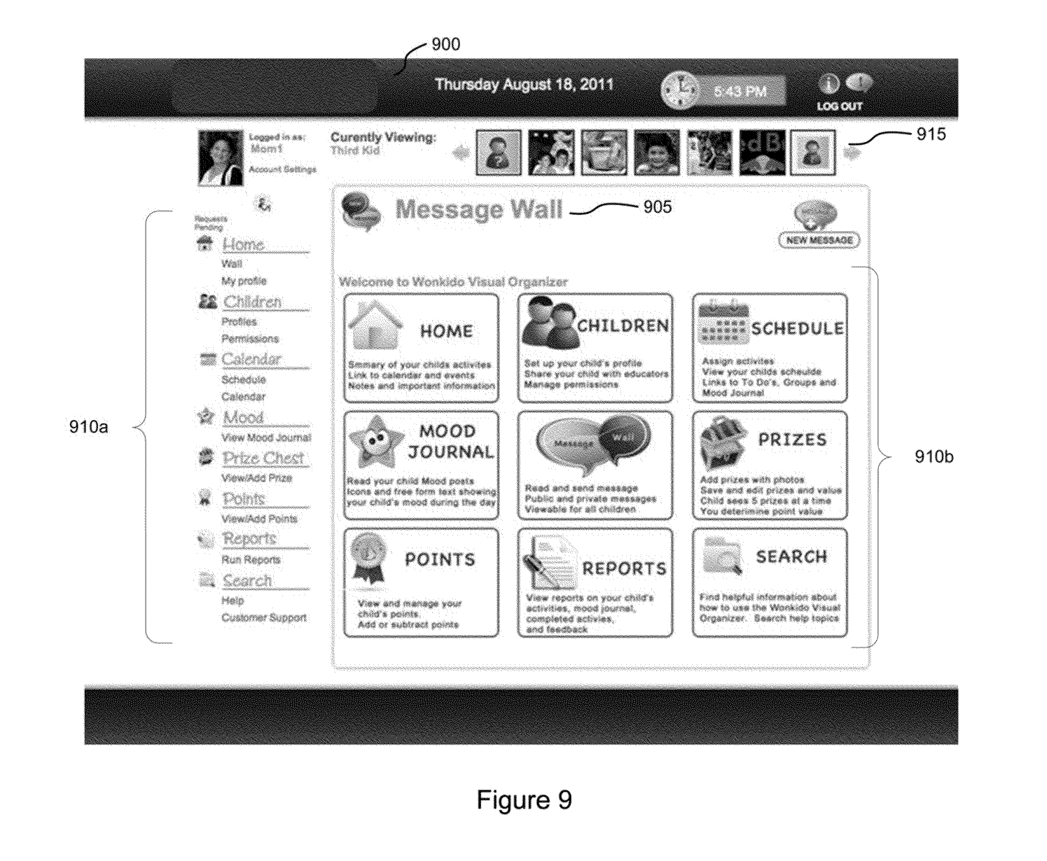

Parents too may be presented with a home screen 900, as illustrated in FIG. 9, which may comprise a summary of their child's daily schedule, to-do activities, as well as other groups they are included in. For example, each group may have a separate calendar and daily schedule. Each activity that applies to a child will also show up on the individual child's schedule, while the group has an isolated schedule to see all activities and messages within the group. The parent home screen 900 may include a portion of the aforementioned message wall 905, navigation areas/icons/links such as 910a and 910b that will direct the user to the various aspects of the application, and a selection area 915 where the parent may select which child's account he/she wishes to see (if more than one child exists). A parent will be able to add important links and will have icons linking them to important shortcuts within the application, and search for relevant data or information.

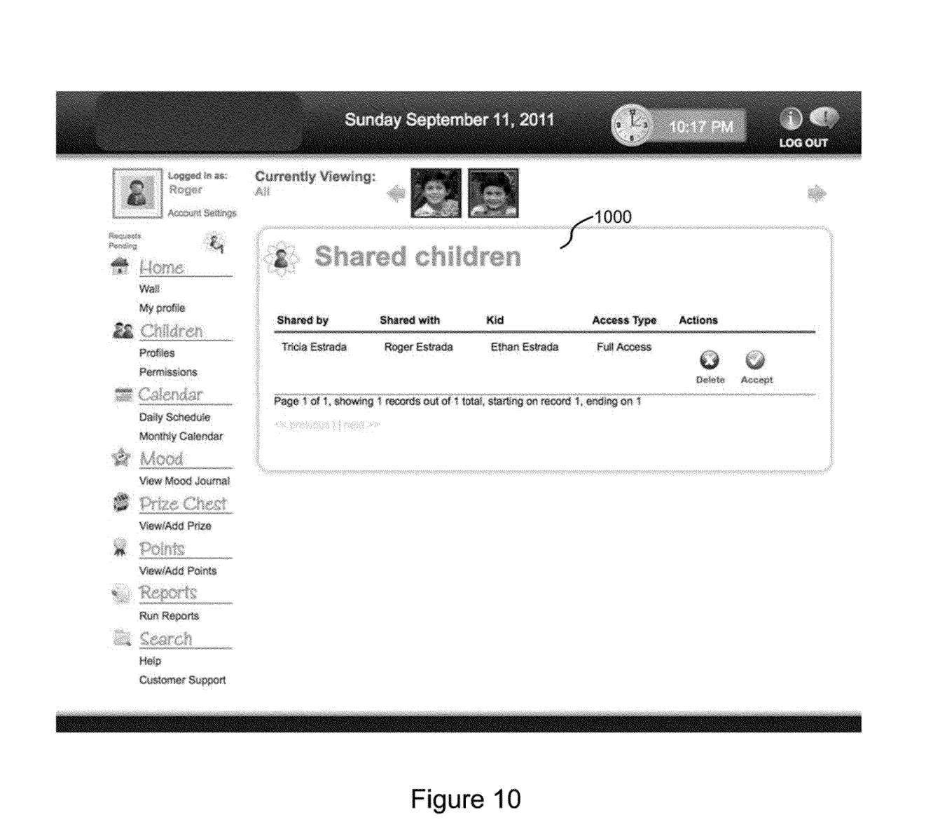

As also described above, children can be shared with other parents, educators, adults, etc. FIG. 10 illustrates and exemplary sharing screen 1000. A parent may indicate what other entities his/her child is to be shared with, what type of access those other entities may have with regard to the child's account/profile, as well as options to delete a sharing entity. It should be noted that although FIGS. 9 and 10 illustrate exemplary screens displayed for a parent, other account administrators/adults are able to set up accounts, share accounts with other adult entities, etc., and may be presented with substantially similar and/or entity-appropriate displays.

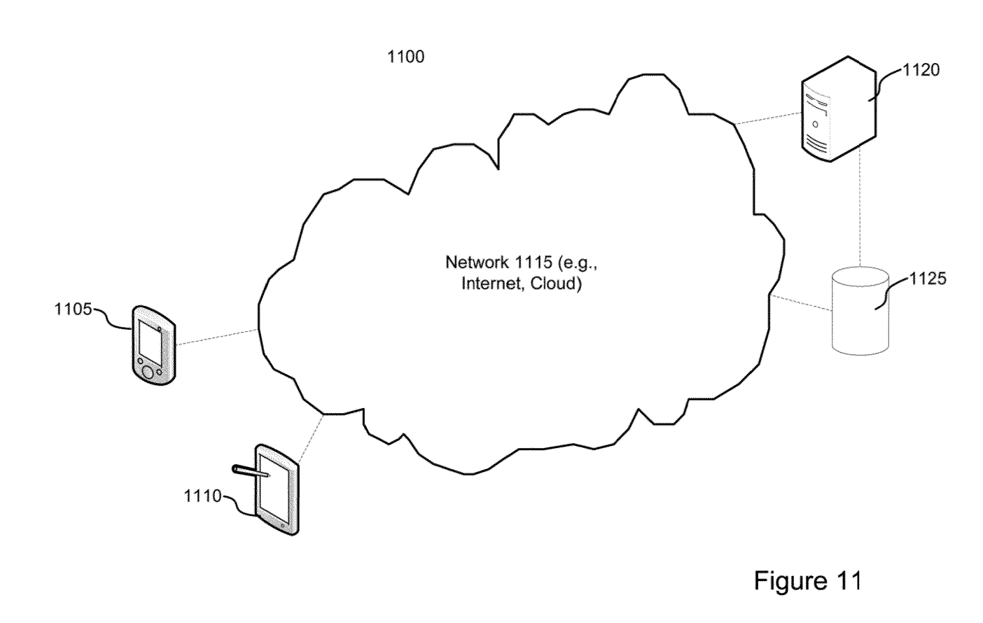

In accordance with one embodiment, the visual organizer application may be implemented as a standalone application/tool. FIG. 11 illustrates an exemplary system architecture in accordance with this embodiment. The application in this embodiment may be a standalone application that is loaded onto and executed on an electronic device, such as a tablet PC, smart phone, PDA, etc. In order to implement the aforementioned instances of the application for different users, each of the different users may have unique logins to the application, and the device itself may be shared between the users.

In accordance with another embodiment, the visual organizer may be implemented as an application on an electronic device having communication capabilities (via, e.g., one or more transceiver radios, communication modules, etc.), such as WiFi or other local area network (LAN) connectivity. In this embodiment, “localized” collaboration can be achieved. A first user, e.g., a child, utilizes an instance of the application on his/her electronic device, while a second user, e.g., a parent, utilizes another instance of the application on his/her electronic device. Communications, sharing of information (e.g., mood journal information, schedule, to-do activities, etc.) between the child and the parent is achieved by exchanging and/or simultaneously keeping synchronized one or files having the appropriate information/data. The file may be shared between the child and the parent via a local area network (LAN), using WiFi capabilities of their respective electronic devices. Alternatively, reports, periodic status updates or the like may be outputted in some tangible format using, e.g., another presentation-based peripheral. For example, a schedule may be stored on a removable memory unit and transferred between the electronic devices, although it is preferred that the information is available device to device via the cloud and synchronization mechanisms as in most implementations, the cloud has the most up to date information for each account.

In accordance with yet another embodiment, a cloud-based or data network (e.g., Internet) system architecture may be utilized. FIG. 11 illustrates an exemplary system architecture 1100, where, a first user, e.g., a child, utilizes an instance of the visual organizer on his/her electronic device 1105, while a second user, e.g., a parent, utilizes another instance of the visual organizer on his/her electronic device 1110. Communications, schedule synchronization, etc. is achieved by exchanging one or more files representative of the relevant communications, schedule data, etc. However, instead of utilizing LAN connectivity, communications are achieved using a cloud network 1115, where the one or more files are stored as cloud data on one or more server computers. Alternatively, the instances of the visual organizer may not necessarily be implemented as client-specific applications on the electronic devices 1105 and 1110, but rather as a web-based application (hosted by a web server 1120 and data repository 1125 connected to the electronic devices 1105 and 1110 via a data network 1115 such as the Internet) executed and managed by, e.g., a web browser of the electronic devices 1105 and 1110.

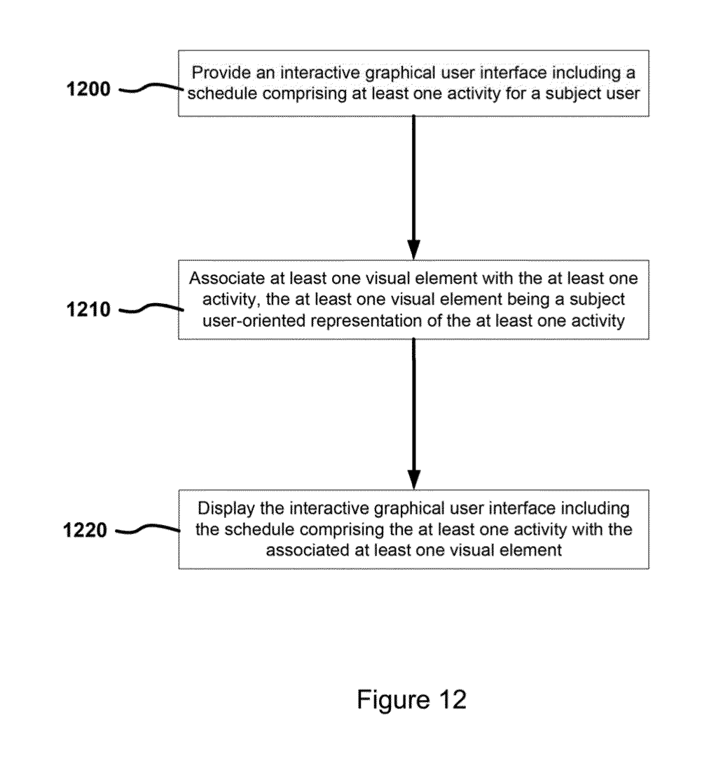

FIG. 12 is a flow chart illustrating exemplary processes performed in accordance with various embodiments for presenting an interactive visual organizer application to a user, such as a child, parent, educator, etc. At 1200, an interactive graphical user interface including a schedule, where the schedule comprises at least one activity for a child is provided. At 1210, a visual element, such as one or more icons, photographs, or other types of media, are associated. with the at least one activity, the visual element being a child-oriented representation of the at least one activity. At 1220, the interactive graphical user interface including the schedule comprising the at least one activity, along with the associated visual element is displayed.

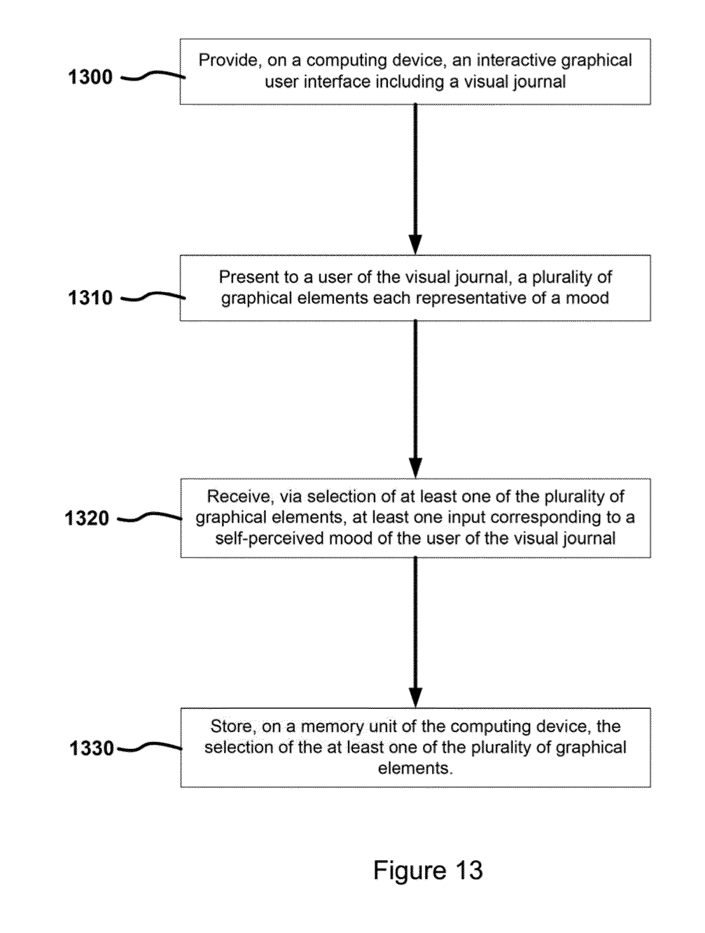

FIG. 13 is a flow chart illustrating exemplary processes performed in accordance with other various embodiments for presenting an interactive visual organizer application to a user, such as a child, parent, educator, etc. At 1300, an interactive graphical user interface which includes a visual journal is provided on a computing device, such as a table PC, a smartphone, etc. At 1310, a plurality of graphical elements each representative of a mood are presented to a user of the visual journal. For example, icons/pictures indicative of sadness, happiness, etc. may be presented. At 1320, at least one input corresponding to a self-perceived mood of the user of the visual journal is received via selection of at least one of the plurality of graphical elements. At 1330, the selection of the at least one of the plurality of graphical elements is stored on a memory unit of the computing device.

While various embodiments of the present invention have been described above for visual organizer systems and methods, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Moreover, while various embodiments have been described in the context of aiding children, other contemplated subject users may include, but are not limited to, e.g., teenagers/high school students, college students, adults with needs, or any person that may benefit from the visually-oriented organizer and/or other functionality described herein. Thus, contemplated administrator/supervisor/educator/participating users may include not only parents, child educators, and the like, but also high school and college educators, adult therapists, etc.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

Moreover, various embodiments described herein are described in the general context of method steps or processes, which may be implemented in one embodiment by a computer program product, embodied in a computer-readable memory, including computer-executable instructions, such as program code, executed by computers in networked environments. A computer-readable memory may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes. Various embodiments may comprise a computer-readable medium including computer executable instructions which, when executed by a processor, cause an apparatus to perform the methods and processes described herein.

Furthermore, embodiments of the present invention may be implemented in software, hardware, application logic or a combination of software, hardware and application logic. The software, application logic and/or hardware may reside on a client device, a server or a network component. If desired, part of the software, application logic and/or hardware may reside on a client device, part of the software, application logic and/or hardware may reside on a server, and part of the software, application logic and/or hardware may reside on a network component. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer. A computer-readable medium may comprise a computer-readable storage medium that may be any media or means that can contain or store the instructions for use by or in connection with an instruction execution system, apparatus, or device, such as a computer. In one embodiment, the computer-readable storage medium is a non-transitory storage medium.

What is claimed is:

1. A method, comprising:
providing an interactive graphical user interface including a schedule comprising at least one activity for a subject user;
associating at least one visual element with the at least one activity, the at least one visual element being a subject-user-oriented representation of the at least one activity; and
displaying the interactive graphical user interface including the schedule comprising the at least one activity with the associated at least one visual element.

2. The method of claim 1, wherein the activity is associated with at least one of a completion date and a completion time.

3. The method of claim 1, wherein the at least one activity is not associated with either a completion date or a completion time.

4. The method of claim 1, wherein the at least one activity comprises an educator-created lesson.

5. The method of claim 1, wherein the at least one activity comprises a plurality of steps to be completed by the subject user.

6. The method of claim 5, wherein the associating of the at least one visual element with the at least one activity comprises associating each of the plurality of steps with a visual element associated with the at least one visual element.

7. The method of claim 1 further comprising, providing and displaying at least one of an interactive calendar, an interactive to-do list, an interactive mood journal, accumulated points associated with completion by the subject user of at least one activity, messages, and a motivational prize listing associated with the accumulated points.

8. The method of claim 7, wherein the interactive mood journal provides at least one of visual mood representation selection and a mood recording capability.

9. The method of claim 7, wherein the providing and displaying of the messages comprises posting the messages on an interactive message wall.

10. The method of claim 1 further comprising, presenting a lesson-related graphical user interface configured to provide at least one of lesson creation capability, lesson searching capability, and lesson assignment capability to one of the subject user or a group of users including the subject user.

11. The method of claim 1 further comprising, presenting a group management graphical user interface configured to provide group management capability of at least one group comprising, in part, the subject user.

12. A computer-readable memory including computer executable instructions, the computer executable instructions, which when executed by a processor, cause an apparatus to perform a method as claimed in claim 1.

13. An apparatus, comprising:
at least one processor; and
at least one memory including computer program code, the at least one memory and the computer program code configured to, with the at least one processor, cause the apparatus to perform at least the following:
provide an interactive graphical user interface including a schedule comprising at least one activity for a subject user;
associate at least one visual element with the at least one activity, the at least one visual element being a subject user-oriented representation of the at least one activity; and
display the interactive graphical user interface including the schedule comprising the at least one activity with the associated at least one visual element.

14. The apparatus of claim 13, wherein the activity has at least one of an associated completion date and an associated completion time.

15. The apparatus of claim 13, wherein the at least one activity is not associated with either a completion date or a completion time.

16. The apparatus of claim 13, wherein the at least one activity comprises an educator-created lesson.

17. The apparatus of claim 13, wherein the at least one activity comprises a plurality of steps to be completed by the subject user.

18. The apparatus of claim 17, wherein to perform the associating of the at least one visual element with the at least one activity, the at least one memory and the computer program code configured to, with the at least one processor, cause the apparatus to associate each of the plurality of steps with a visual element associated with the at least one visual element.

19. The apparatus of claim 13, wherein the at least one memory and the computer program code configured to, with the at least one processor, further cause the apparatus to provide and display at least one of an interactive calendar, an interactive to-do list, an interactive mood journal, accumulated points associated with completion by the subject user of at least one activity, messages, and a motivational prize listing associated with the accumulated points.

20. The apparatus of claim 19, wherein the interactive mood journal provides at least one of visual mood representation selection and a mood recording capability.

21. The apparatus of claim 19, wherein to perform the providing and displaying of the messages, the at least one memory and the computer program code configured to, with the at least one processor, cause the apparatus to post the messages on an interactive message wall.

22. The apparatus of claim 13, wherein the at least one memory and the computer program code configured to, with the at least one processor, further cause the apparatus to present a lesson-related graphical user interface configured to provide at least one of lesson creation capability, lesson searching capability, and lesson assignment capability to one of the subject user or a group of users including the subject user.

23. The apparatus of claim 13, wherein the at least one memory and the computer program code configured to, with the at least one processor, further cause the apparatus to present a group management graphical user interface configured to provide group management capability of at least one group comprising, in part, the subject user.

24. A system, comprising:
a first device executing a first instance of an interactive visual organizer application;
a second device executing a second instance of the interactive visual organizer application; and
a data network communicatively connecting the first device and the second device, the data network ensuring synchronization of the first instance of the interactive visual organizer application and the second instance of the interactive visual organizer application; the interactive visual organizer being configured to:
provide an interactive graphical user interface including a schedule comprising at least one activity for a subject user utilizing the first device;
associate at least one visual element with the at least one activity, the at least one visual element being a subject user-oriented representation of the at least one activity; and
display the interactive graphical user interface including the schedule comprising the at least one activity with the associated at least one visual element.

25. The system of claim 24, wherein the interactive visual organizer is further configured to provide and display at least one of an interactive calendar, an interactive to-do list, an interactive mood journal, accumulated points associated with completion by the subject user of at least one activity, messages, and a motivational prize listing associated with the accumulated points.

26. The system of claim 24, wherein the data network comprises a private educator network.

27. The system of claim 26, wherein the synchronization of the first instance of the interactive visual organizer application and the second instance of the interactive visual organizer application comprises automatically updating the second instance of the interactive visual organizer application via the private educator network based upon an action undertaken on the first instance of the interactive visual organizer application regarding the at least one activity.

28. A method, comprising:
providing, on a computing device, an interactive graphical user interface including a visual journal;
presenting to a user of the visual journal, a plurality of graphical elements each representative of a mood;
receiving, via selection of at least one of the plurality of graphical elements, at least one input corresponding to a self-perceived mood of the user of the visual journal; and
storing, on a memory unit of the computing device, the selection of the at least one of the plurality of graphical elements.

29. The method of claim 28 further comprising, providing at least one of a text recorder and an audio recorder, the text recorder and the audio recorder being configured to record a freeform textual entry and a freeform audio entry, respectively, of the user pertaining to the self-perceived mood of the user.

30. The method of claim 29 further comprising, automatically sending a notification to an administrator upon the recording of the freeform entry.

31. The method of claim 28 further comprising, automatically sending a notification to an administrator upon the receipt of the at least one input.

32. The method of claim 28 further comprising, displaying an indication of the self-perceived mood of the user of the visual journal within the interactive graphical user interface upon the receipt of the at least one input.

33. An apparatus, comprising:
at least one processor; and
at least one memory including computer program code, the at least one memory and the computer program code configured to, with the at least one processor, cause the apparatus to perform at least the following:
provide an interactive graphical user interface including a visual journal;
present to a user of the visual journal, a plurality of graphical elements each representative of a mood;
receive, via selection of at least one of the plurality of graphical elements, at least one input corresponding to a self-perceived mood of the user of the visual journal; and
store, on a memory unit, the selection of the at least one of the plurality of graphical elements.

34. The apparatus of claim 33 further comprising, at least one of a text recorder and an audio recorder, the text recorder and the audio recorder being configured to record a freeform textual entry and a freeform audio entry, respectively, of the user pertaining to the self-perceived mood of the user.

35. The apparatus of claim 34 further comprising, a communications module configured to automatically send a notification to an administrator upon the recording of the freeform entry.

36. The apparatus of claim 33 further comprising, a communications module configured to automatically send a notification to an administrator upon the receipt of the at least one input.

37. The apparatus of claim 33, wherein the at least one memory and the computer program code configured to, with the at least one processor, further cause the apparatus to display an indication of the self-perceived mood of the user of the visual journal within the interactive graphical user interface upon the receipt of the at least one input.
